(19) United States
(12) Patent Application Publication
(10) Pub. No.: US 2016/0345716 A1
(43) Pub. Date: Dec. 1, 2016

(54) NEO-S (Neodymium Sleeve)

(71) Applicant: Justin Gerald Head, Leesville, SC (US)

(72) Inventor: Justin Gerald Head, Leesville, SC (US)

(21) Appl. No.: 14/702,699

(22) Filed: May 26, 2015

(51) Int. Cl. A45F 5/02; G02C 3/04

(52) U.S. Cl. CPC A45F 5/02; G02C 3/04; A45F 2200/0541

(57) ABSTRACT

An elastic tubular shaped sleeve having a set of magnets integrated into the diameter of the said sleeve walls to be positioned over the temple “arms” of eyeglasses for the purpose of securely fastening aforementioned eyeglasses to an article of one's clothing and accessories by means of closing the “arms” together allowing the magnets to attract to one another causing a clip to be produced.

### SUMMARY OF INVENTION

The NEO-S describes the integration of a small and powerful neodymium magnet built into an approximately 1″ rubber tube, to be slid onto the “arms” of sunglasses and reading glasses for the purpose of safely securing said glasses to an article of a person's clothing. By closing the arms together, the user would be allowing the magnets within the rubber tubes to attract to one another thus causing a “clip” to be produced. When contact is made, the glasses are securely fastened to the wearer's clothing preventing them from being able to fall off freely. To disengage the magnetic “clip” the wearer would simply pull outward on the glasses thus loosening the magnetic attraction between the two poles and releasing the glasses.

### BRIEF DESCRIPTION OF DRAWINGS

FIG. 1 is an isometric cross-sectional view of NEO-S according to a preferred embodiment of invention.

FIG. 1A is a front cross-sectional view of said NEO-S, showing the neodymium magnets inside of the rubber sleeve.

FIG. 2 is an isometric view of the aforementioned sunglasses with the NEO-S fastened on the “arms”.

FIG. 3 is a top view of the sunglasses with NEO-S fastened to the arms illustrating the magnetic attraction between the sleeves when the arms are closing.

FIGS. 3A AND 3B are enlarged cross-sectional views of FIG. 3

FIG. 4 is a back view of sunglasses in the closed position

FIG. 4B is an enlarged cross-sectional view of FIG. 4

FIG. 5 is an illustration showing the desired purpose of the invention. To safely secure the sunglasses to an article of clothing by “clipping” the magnetic sleeves together.

### DETAILED DESCRIPTION OF THE PREFERRED EMBODIMENT

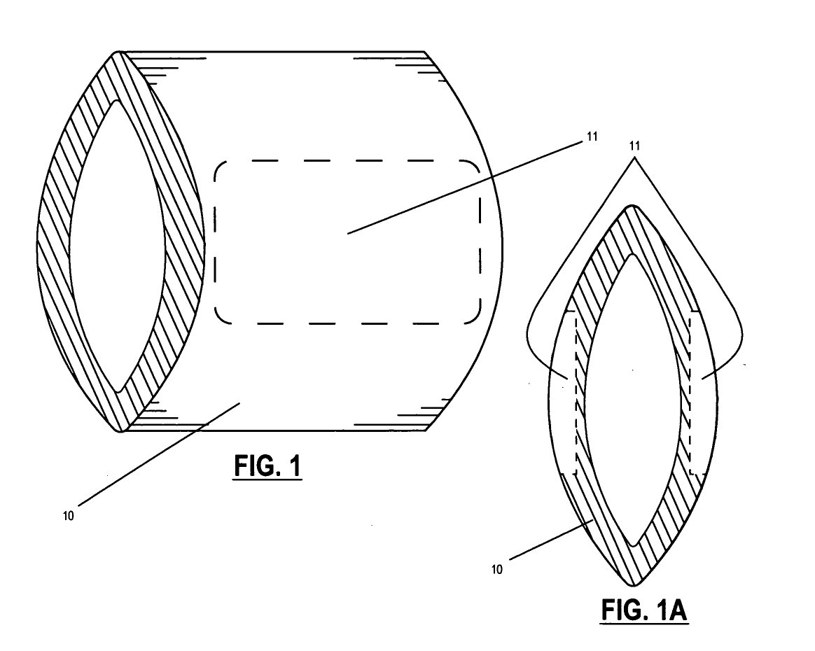

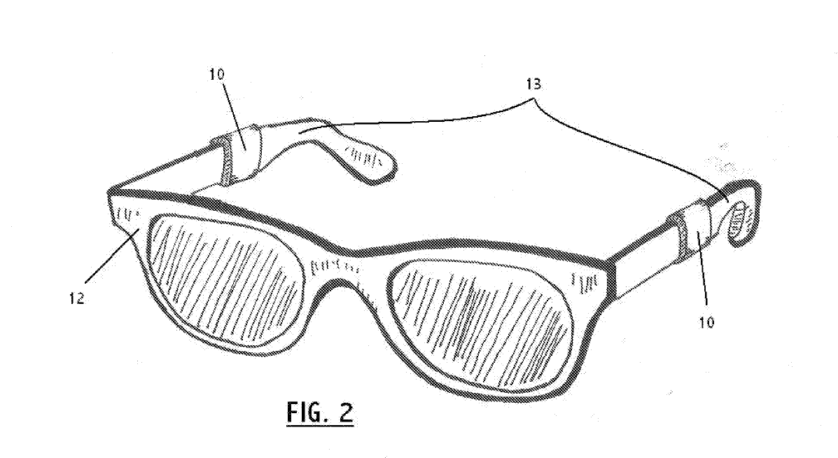

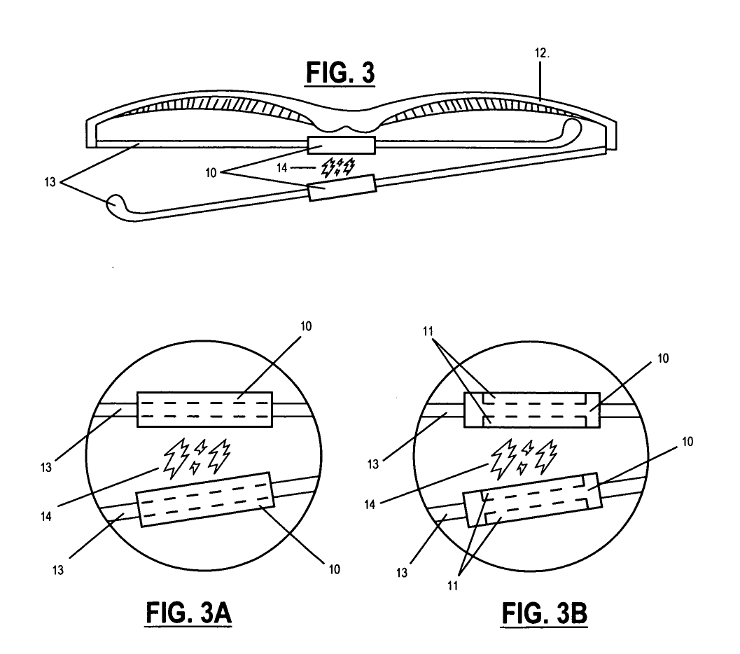

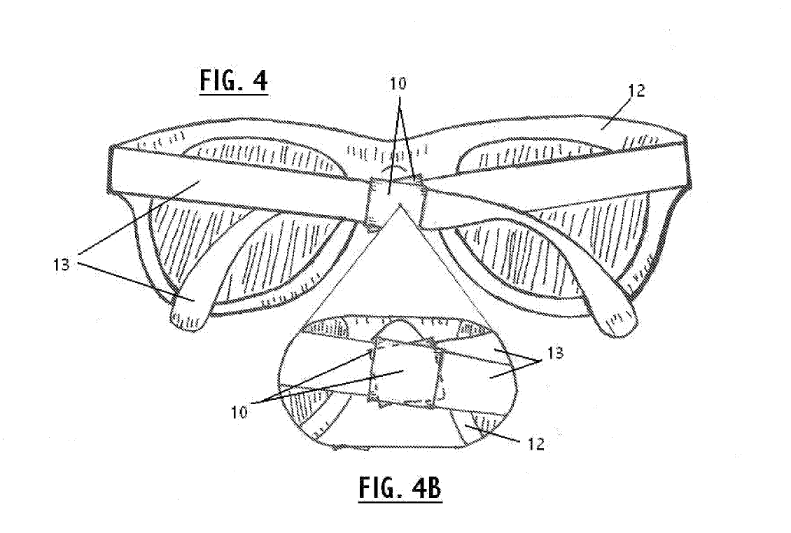

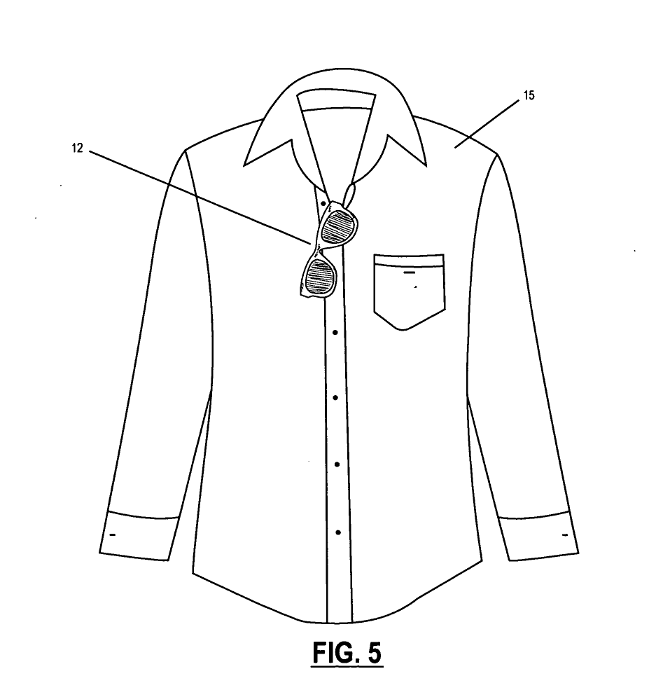

The Neodymium sleeve 10 houses two small Neodymium magnets 11 integrated into the walls of the sleeve 10 (As shown in FIGS. 1 and 1A). The sleeve 10 is to be slid over the “arms” 13 of the sunglasses 12. When the arms 13 are in the open position as in FIG. 2, the magnets 11 do not interact with one another. However, when the arms 13 are closing together (FIG. 3) the magnetic attraction 14 creates a “clip” for the purpose of securely fastening the glasses 12 to an article of a person's clothing 15.

What I claim is:

1. A tubular latex sleeve having a set of Neodymium magnets integrated into the diameter of the sleeve walls, comprising;
a tubular latex sleeve; having
a set of Neodymium magnets integrated into the diameter of said sleeve walls,
whereby the sleeve can be fastened over the temple “arms” of eyeglasses to form a magnetic Neodymium clip for the purpose of said eyeglasses being securely fastened to articles of one's clothing and accessories.

2. A generally tubular elastic sleeve having a set of magnets integrated into the diameter of the sleeve walls, comprising;
an elastic sleeve; having
a set of magnets integrated into the diameter of said sleeve walls,
whereby the sleeve can be fastened over the temple “arms” of eyeglasses to form a magnetic clip for the purpose of said eyeglasses being securely fastened to articles of one's clothing and accessories.
